(19) United States
(12) Patent Application Publication
(10) Pub. No.: US 2026/0230568 A1
(43) Pub. Date: Aug. 6, 2026

(54) STORAGE MEDIUM STORING APPLICATION PROGRAM, CONTROL METHOD, AND INFORMATION PROCESSING APPARATUS

(71) Applicant: CANON KABUSHIKI KAISHA, Tokyo (JP)

(72) Inventor: HIROYUKI SAKAI, Chiba (JP)

(21) Appl. No.: 19/423,318

(22) Filed: Dec. 17, 2025

(30) Foreign Application Priority Data
Dec. 26, 2024 (JP) 2024-230192

(51) Int. Cl. H04N 1/00; G06F 3/12

(52) U.S. Cl. CPC H04N 1/00482; G06F 3/1205; G06F 3/1228; G06F 3/1255; H04N 1/00206; H04N 1/00503; H04N 2201/0093; H04N 2201/0094

(57) ABSTRACT

A non-transitory computer-readable storage medium storing an application program causing a computer to execute a method. The method includes supporting a standard driver provided from a provider of an operating system, and displaying a setting reception screen which receives a setting for executing both of processing for transmitting image data and processing for performing printing based on the image data.

### BACKGROUND

### Field of the Technology

The present disclosure relates to a storage medium storing an application program, a control method, and an information processing apparatus.

### Description of the Related Art

In recent years, in Windows (registered trademark), a standard class driver (hereinafter sometimes referred to as the “standard driver”) is provided, which can be commonly used even for image forming apparatuses having a print function, supplied from a plurality of different vendors, respectively. Such a standard driver is incorporated in an operating system (OS) in advance. Then, the standard driver can be used by connecting a desired image forming apparatus to a host computer having the OS incorporating the standard driver. This makes it possible to omit installation of a model-specific printer driver. Further, with the standard driver, a print function of the image forming apparatus can be designated and used according to print device capabilities (hereinafter referred to as the “PDC”) generated based on information acquired from the image forming apparatus. This makes it possible to designate a print function on an image forming apparatus-by- image forming apparatus basis by one standard driver. A function extension application (hereinafter sometimes referred to as the “extension application”) for extending a function can be associated with the standard driver. The extension application is provided from each vendor. Therefore, it is difficult to execute functions of the extension application only with the standard driver.

Japanese Laid-Open Patent Publication (Kokai) No. 2023-80177 discloses a program for displaying, on an information processing apparatus connected to an image forming apparatus, an input screen (FAX setting UI) on which transmission destination information necessary for FAX transmission performed by the image forming apparatus is input. Further, in the image forming apparatuses, there is known an apparatus having a simultaneous transmission-and-printing function. The “simultaneous transmission-and-printing function” refers to a function of the image forming apparatus, for simultaneously performing FAX transmission and printing of an image transmitted by FAX.

However, with the standard driver, it is impossible to cause the image forming apparatus to execute the simultaneous transmission-and-printing function.

### SUMMARY

The present disclosure is directed to providing a mechanism that receives a setting for executing both of processing for transmitting image data and processing for performing printing based on the image data.

In a first aspect of the present disclosure, there is provided a non-transitory computer-readable storage medium storing an application program causing a computer to execute a method, the method including supporting a standard driver provided from a provider of an operating system, and displaying a setting reception screen which receives a setting for executing both of processing for transmitting image data and processing for performing printing based on the image data.

In a second aspect of the present disclosure, there is provided a control method including supporting a standard driver provided from a provider of an operating system by executing an application program, and displaying, by executing the application program, a setting reception screen which receives a setting for executing both of processing for transmitting image data and processing for performing printing based on the image data.

Features of the present disclosure will become apparent from the following description of embodiments with reference to the attached drawings. The following description of embodiments are described by way of example.

### BRIEF DESCRIPTION OF THE DRAWINGS

FIG. 1 is a block diagram showing a hardware configuration of a printing system according to a first embodiment.

FIGS. 2A and 2B are block diagrams each showing a software configuration of the printing system.

FIGS. 3A-A to 3A-C are diagrams each showing an example of a screen displayed on a display section of the printing system in a case where a printing apparatus has a FAX transmission function.

FIGS. 3B-A and 3B-B are diagrams useful in explaining simultaneous FAX transmission-and-printing.

FIGS. 3C-A and 3C-B are diagrams each showing an example of a screen displayed on the display section of the printing system in a case where the printing apparatus does not have the FAX transmission function.

FIG. 4 is a flowchart of a process performed by a print function-extending unit for editing print function information.

FIG. 5 is a diagram showing an example of a list of capabilities information of the printing apparatus.

FIG. 6 is a diagram showing an example of a list of functions supported by an extension application.

FIG. 7 is a diagram showing an example of a list of capabilities information of general-purpose print software.

FIG. 8 is a sequence diagram showing a process executed between a drawing application, the general-purpose print software, the extension application, and the printing apparatus, after the drawing application receives FAX settings.

FIG. 9 is a flowchart of a process performed by the extension application.

FIG. 10A is a diagram showing an example of a screen displayed on a display section of a printing system according to a second embodiment.

FIG. 10B is a diagram showing a variation of the screen displayed on the display section of the printing system according to the second embodiment.

FIG. 11 is a sequence diagram showing a process executed between the drawing application, the general-purpose print software, the extension application, and the printing apparatus, after the drawing application receives FAX settings.

FIG. 12 is a diagram showing an example of a screen displayed on a display section of a printing system in a case where a printing apparatus according to a third embodiment has the FAX transmission function.

FIG. 13 is a sequence diagram showing a process executed between the drawing application, the general-purpose print software, the extension application, and the printing apparatus, after the drawing application receives FAX settings.

FIG. 14 is a block diagram showing a software configuration of a printing system according to a fourth embodiment.

FIGS. 15A and 15B are diagrams each showing an example of a screen displayed on the display section of the printing system in a case where the printing apparatus has the FAX transmission function.

FIG. 16 is a sequence diagram showing a process executed between the drawing application, the general-purpose print software, the extension application, and the printing apparatus, after the drawing application receives FAX settings.

### DESCRIPTION OF THE EMBODIMENTS

The present disclosure will now be described in detail below with reference to the accompanying drawings showing embodiments thereof. The configuration described in the following embodiments is given only by way of example, and is by no means intended to limit the scope of the present disclosure. For example, components of the configuration of the present disclosure can be replaced with desired components which can exhibit the same functions. Further, desired components can be added. Further, two or more desired components (features) of the embodiments can be combined.

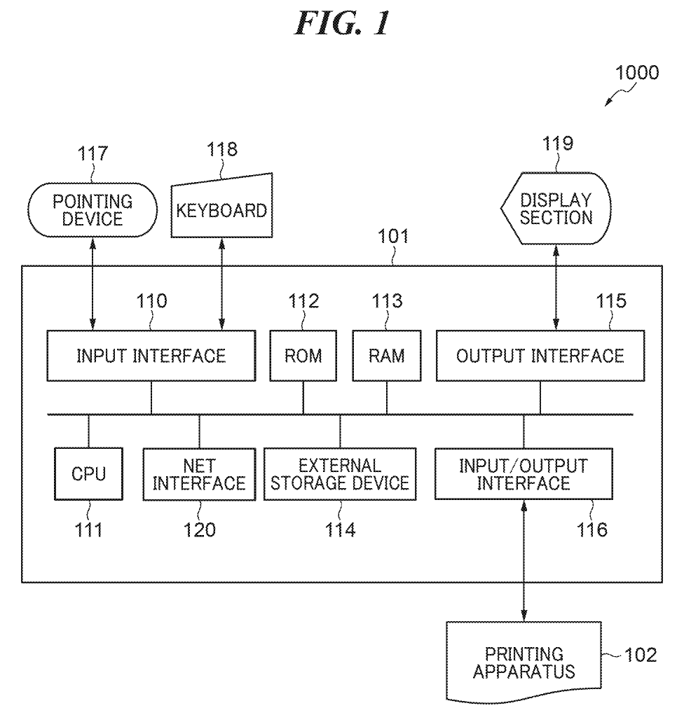

A first embodiment will be described below with reference to FIGS. 1 to 9.

FIG. 1 is a block diagram showing a hardware configuration of a printing system according to the first embodiment. As shown in FIG. 1, the printing system, denoted by reference numeral 1000, includes a host computer 101, a printing apparatus 102, a pointing device 117, a keyboard 118, and a display section 119, and these are communicably connected to each other. The host computer 101 is an information processing apparatus and includes an input interface 110, a central processing unit (CPU) 111, a read only memory (ROM) 112, a random access memory (RAM) 113, an external storage device (storage medium) 114, an output interface 115, an input/output interface 116, and a network (NET) interface 120. Note that although, as the host computer 101, for example, a desktop-type personal computer can be used, this is not limitative, but, for example, any of a laptop-type personal computer, a tablet terminal, and a smartphone can be used.

The CPU 111 is a computer that executes programs and the like stored in the ROM 112 or the external storage device 114. With this, the CPU 111 is capable of executing processing steps (control method), described hereinafter. In the ROM 112, an initialization program is stored. In the external storage device 114, an application program group, the OS, print data generation software, and a variety of other data items are stored. Note that in the present embodiment, as the OS, Windows (registered trademark) 11 of Microsoft (registered trademark) has been installed in the host computer 101. The RAM 113 is used e.g. as a work memory when a variety of programs stored in the external storage device 114 are executed, and the variety of programs can operate in the host computer 101. To the input interface 110, the pointing device 117 and the keyboard 118 as input devices are connected. To the output interface 115, the display section 119 as a display device is connected. On the display section 119, for example, a FAX transmission setting UI 301 and a FAX transmission setting UI 211, described hereinafter, are displayed. The NET interface 120 is a network interface and performs control to transfer data to and from an external apparatus via a network. To the input/output interface 116, the printing apparatus 102 is connected. This enables the host computer 101 to communicate with the printing appratuses 102 of a plurality of makers, i.e. process information between the host computer 101 and the printing apparatuses 102 of the plurality of makers, regardless of the maker of the printing apparatus 102.

As the printing apparatus 102, for example, an image forming apparatus (image processing apparatus), such as a multi-function peripheral (MFP) having a plurality of functions, such as copy, print, and FAX functions, can be used, but this is not limitative. Further, printing performed by the printing apparatus 102 is printing by an electrophotographic method in the present embodiment but is not limited to this, and for example, printing by an inkjet method or the like can be performed. Further, although in the present embodiment, the host computer 101 and the printing apparatus 102 are configured as the apparatuses separate from each other, this is not limitative. For example, the host computer 101 and the printing apparatus 102 can be configured as an integrated apparatus.

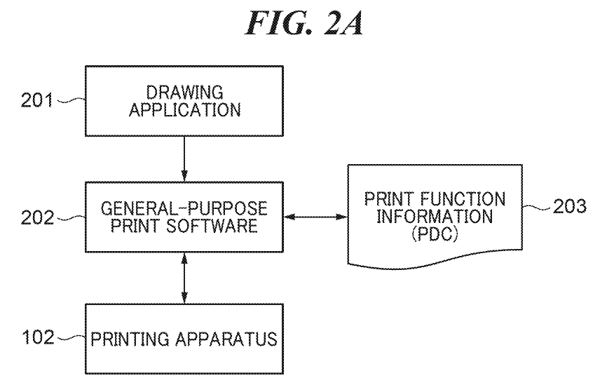

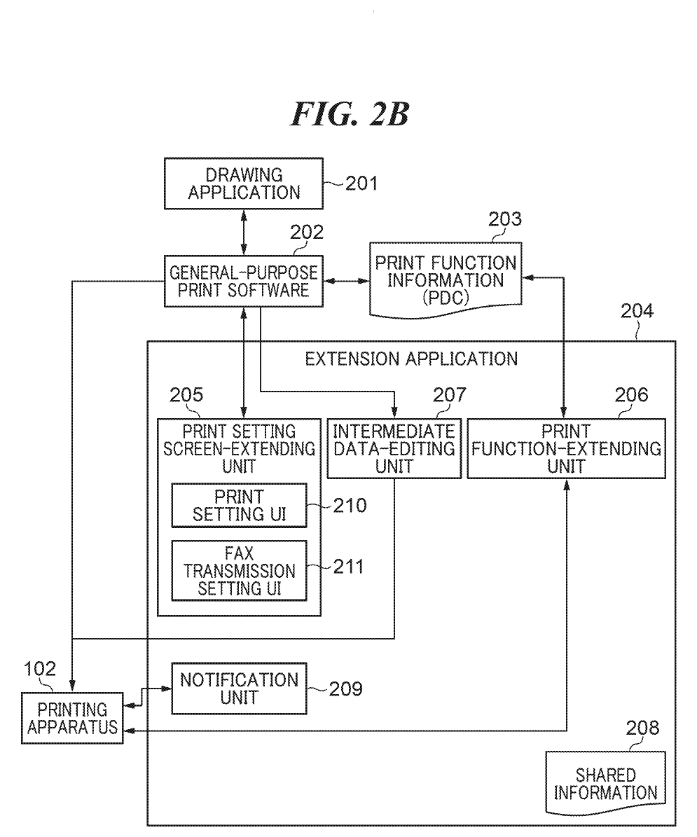

FIGS. 2A and 2B are block diagrams each showing a software configuration of the printing system 1000. FIG. 2A is a diagram showing a general configuration in a case where an extension application (application program) 204 is not associated with general-purpose print software (standard driver) 202 and the printing apparatus 102. FIG. 2B is a diagram showing a configuration in a case where the extension application 204 is associated with the general-purpose print software 202 and the printing apparatus 102. The general-purpose print software 202 is a standard driver provided by the provider of the OS. The standard driver is a class driver (general-purpose program) which can be commonly used for printing apparatuses (the printing apparatuses 102) of a plurality of makers, for example, when printing is performed. The standard driver is installed (incorporated) in the OS in advance, i.e. provided as one of functions in the OS package. The standard driver is capable of performing processing operations for a variety of printing apparatuses by using a standardized printing method. With this, the standard driver can generate and output an instruction which can be interpreted by the printing apparatuses of the plurality of makers. As the general-purpose print software 202, a program operating based on the Internet Printing Protocol (IPP) is used. The extension application 204 is a program supporting i.e. assisting the general-purpose print software 202. In the present embodiment, the extension application 204 is an extension program (application program for executing a control method) capable of extending functions which cannot be executed for the printing apparatus 102 by the general-purpose print software 202, such that the functions can be executed, but is not limited to this. For example, the extension application 204 can be a program which improves the convenience of functions which can be executed by the general-purpose print software 202 for the printing apparatus 102. The extension application 204 is stored e.g. in the external storage device 114 together with the OS (the general-purpose print software 202). With this, the host computer 101 has the general-purpose print software 202 and the extension application 204.

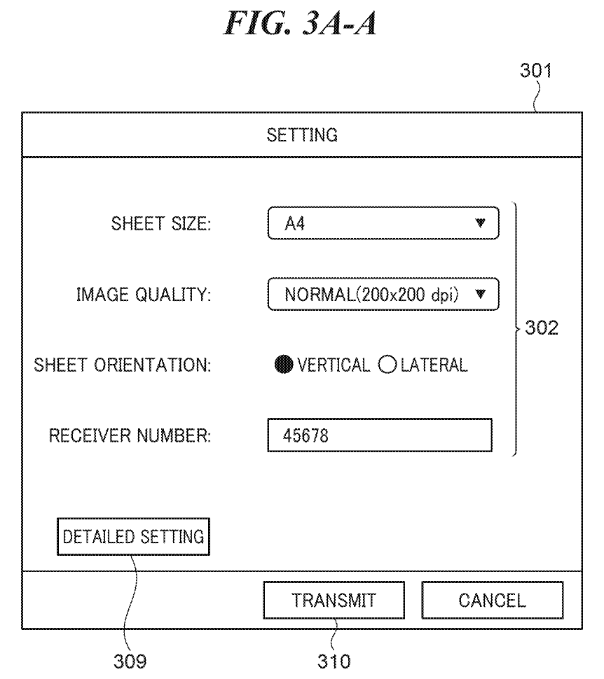

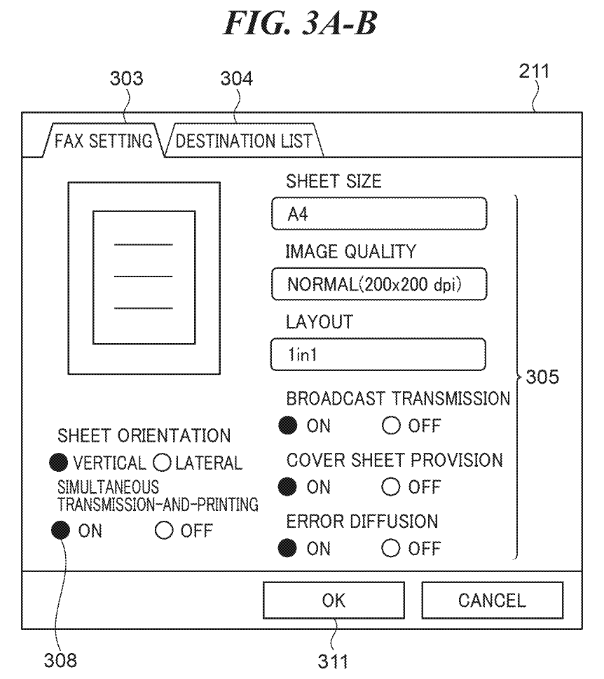

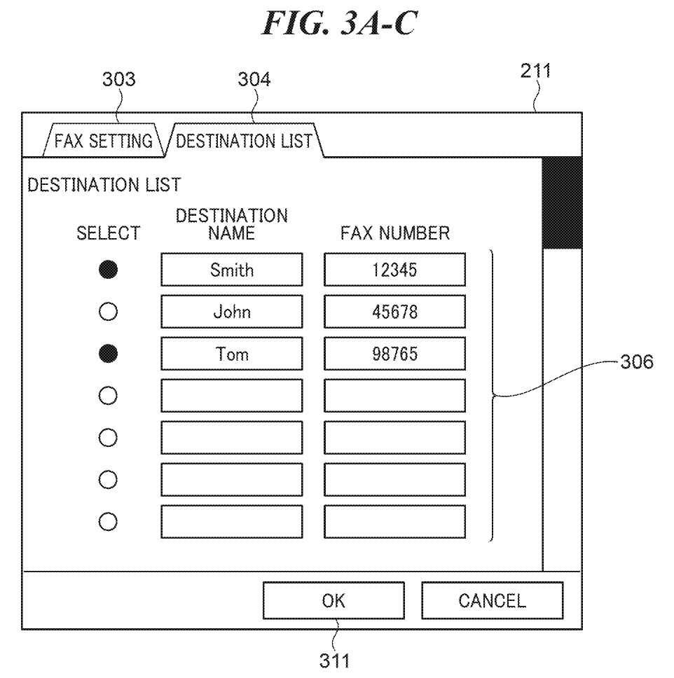

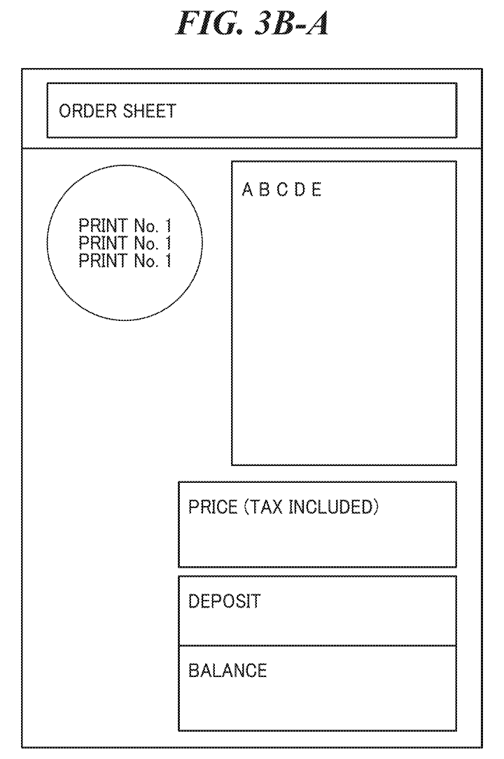

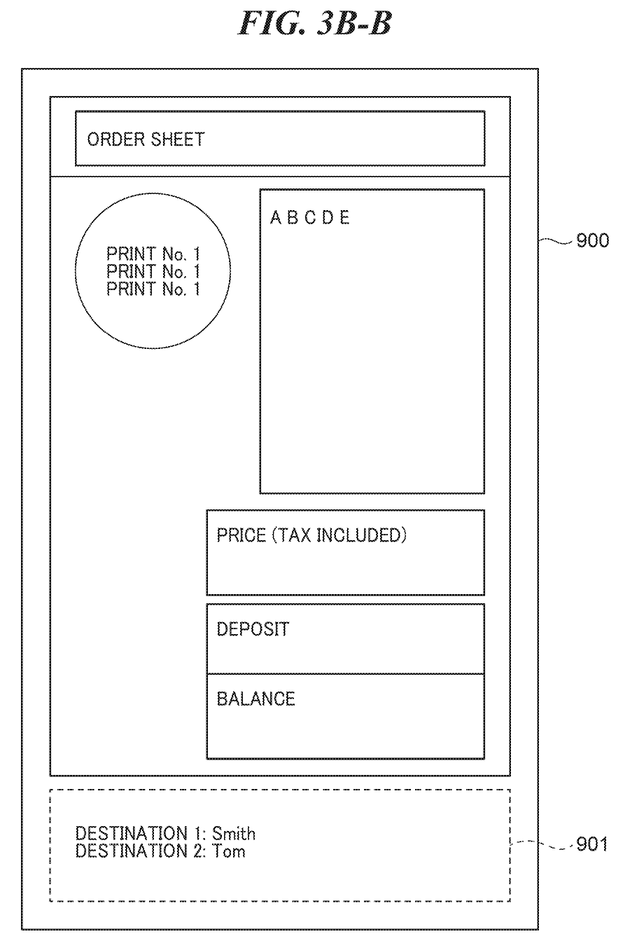

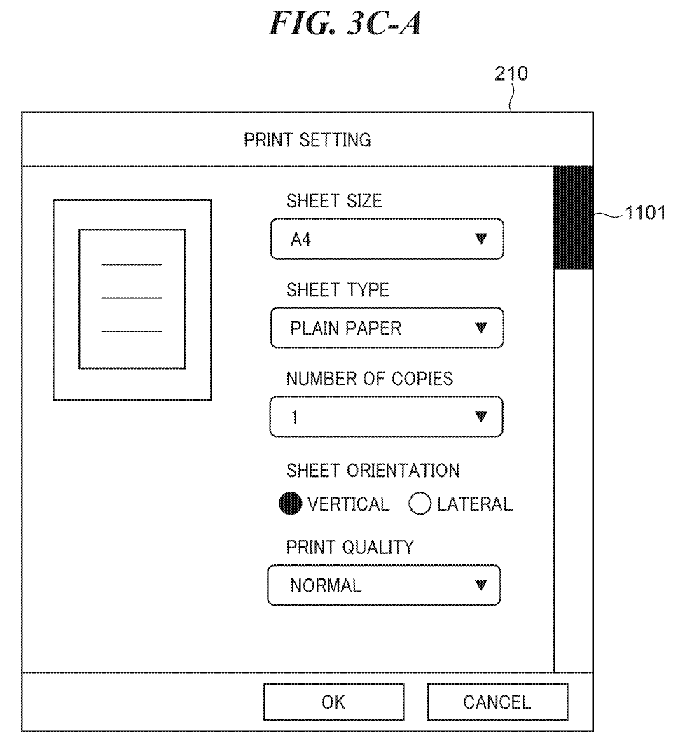

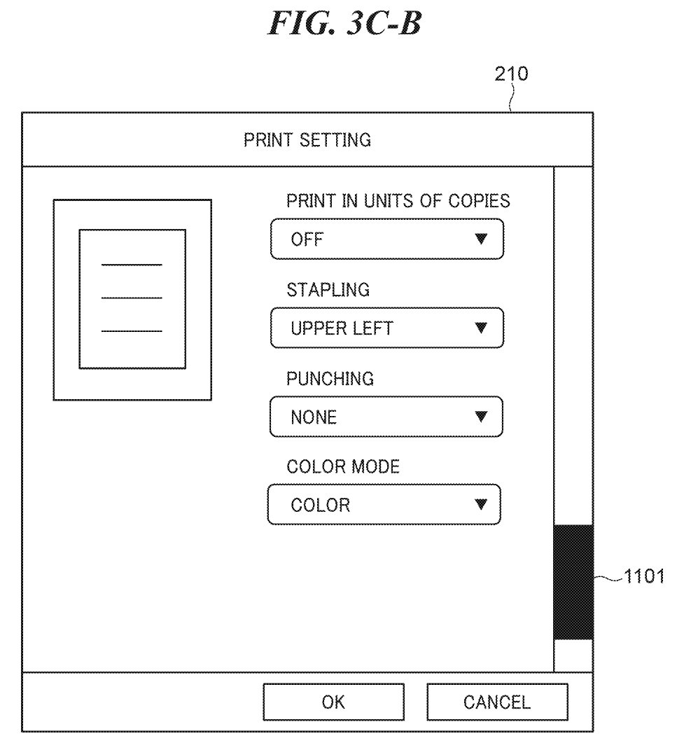

First, referring to FIG. 2A, the configuration in the case where the extension application 204 is not associated with general-purpose print software 202 and the printing apparatus 102 will be described first. A drawing application 201 is software for generating contents (print data) to be printed by the printing apparatus 102. The drawing application 201 is not particularly limited, but, for example, a document generation application, a spreadsheet application or the like can be the drawing application 201. The drawing application 201 issues a print instruction to the OS e.g. upon receipt of a print request from a user via the keyboard 118. The print instruction includes print setting information for instructing operations of the general-purpose print software 202 and the printing apparatus 102. The print setting information is also referred to as the Print Ticket (PT). Further, to output the print setting information, the drawing application 201 can display the FAX transmission setting UI 301 (see FIGS. 3A-A ) provided by one of the general-purpose print software 202, the OS, and the drawing application 201, on the display section 119. Further, by pressing (pressing) a button 309 in the FAX transmission setting UI 301, the drawing application 201 can display the FAX transmission setting UI 211 (see FIGS. 3A-B) on the display section 119. The FAX transmission setting UI 301 and the FAX transmission setting UI 211 will be described hereinafter. A print setting screen includes a setting item indicating a print function which can be set according to capabilities information acquired by the general-purpose print software 202, i.e. information which can be set as the print setting, and a control item indicating its setting. The capabilities information refers to information related to the capabilities of the printing apparatus 102 for performing printing and is also referred to as the Print Capabilities (hereinafter sometimes referred to as the “PC”). Further, with this capabilities information, it is also possible to determine whether or not information which enables the display of the FAX transmission setting UI 211 is included (determination step). Then, as a result of this determination, if it is determined that the information which enables the display of the FAX transmission setting UI 211 is included, the FAX transmission setting UI 211 can be caused to be displayed. On the other hand, if it is determined that the information which enables the display of the FAX transmission setting UI 211 is not included, the display of the FAX transmission setting UI 211 is inhibited. Thus, the extension application 204 can switch whether or not to display the FAX transmission setting UI 211 according to the capabilities information of the printing apparatus 102.

The general-purpose print software 202 determines the PC based on print function information 203. The print function information 203 is data indicating all print functions which can be set, settings of these print functions, and a print function describing an exclusive relation between settings and the like. The print function information 203 is also referred to as the print device capabilities (PDC). The print function information 203 is included in a configuration file of the general-purpose print software 202 and is arranged in the external storage device 114 as an unchangeable file. Alternatively, the print function information 203 is dynamically generated by the general-purpose print software 202. Specifically, the general-purpose print software 202 acquires attribute data of the printing apparatus 102 from the printing apparatus 102. The general-purpose print software 202 generates the print function information 203 according to attribute information in the attribute data. Note that in a case where the print function information 203 is dynamically generated as described above, the print function information 203 can be edited. Further, the attribute data of the printing apparatus 102 refers to a response acquired by issuing a Get-Printer-Attributes operation of the IPP to the printing apparatus 102. The response includes the attribute information indicating the functions which can be designated in the printing apparatus 102, i.e. capabilities of the printing apparatus 102 and settings associated with the attribute information. Further, the response is stored in the RAM 113.

With the configuration described above, the general-purpose print software 202 enables a user to designate a print function which can be used in the printing apparatus 102, according to the printing apparatus 102 connected to the general-purpose print software 202. With this, regardless of the printing apparatus 102 connected to the general-purpose print software 202, i.e. even in a case where the printing apparatus 102 having a different function or the printing apparatus 102 developed by a different printer maker is connected, it is possible to designate a print function which can be used in the connected printing apparatus 102. Note that in the present embodiment, it is assumed that the general-purpose print software 202 is configured to use the IPP Class Driver installed in Windows (registered trademark) 11. The IPP Class Driver is a printer driver that executes print processing according to specifications of a standard print protocol referred to as the IPP, and is incorporated in the OS package. The IPP Class Driver is not a printer driver specific to a model of the printing apparatus 102 but is a standard class driver which can be commonly used for printing apparatuses 102 of printer makers, without depending on a specific printer maker. Further, the IPP Class Driver acquires the capabilities information of the printing apparatus 102 and generates the print function information 203 based on the acquired information.

Further, the general-purpose print software 202 can be associated with the extension application 204. This enables the general-purpose print software 202 to execute a function which is not supported by the general-purpose print software 202. For example, the general-purpose print software 202 cannot execute a function of receiving settings for executing both of processing for transmitting image data by FAX and processing for performing printing based on the image data (hereinafter referred to as the simultaneous FAX transmission-and-printing setting). This is because the simultaneous FAX transmission-and-printing setting is a setting uniquely executed by the printing apparatus 102 manufactured by a predetermined printer maker. The extension application 204 can extend the simultaneous FAX transmission-and-printing setting which cannot be executed by the IPP Class Driver such that the simultaneous FAX transmission-and-printing setting can be executed. Although in the present embodiment, the general-purpose print software 202 cannot execute the simultaneous FAX transmission-and-printing setting, and the extension application 204 can extend the function not supported by the general-purpose print software 202 such that the simultaneous FAX transmission-and-printing setting can be executed, this is not limitative. For example, the IPP Class Driver can execute part of the simultaneous FAX transmission-and-printing setting, and the extension application 204 can further extend the execution range by compensating for the shortage of the simultaneous FAX transmission-and-printing setting. Note that the simultaneous FAX transmission-and-printing will be described in detail hereinafter.

The OS generates intermediate data (sometimes referred to as the input data) based on a print instruction output from the drawing application 201 and transmits the generated intermediate data to the general-purpose print software 202. The data to be output for printing from the drawing application 201 is not particularly limited, but, for example, data of the XML Paper Specification format (XPS format) is preferable. Further, as the data to be output for printing from the drawing application 201, data of the Graphic Device Interface format (GDI format) can be used. In a case where the IPP Class Driver is used as the general-purpose print software 202, if data output from the drawing application 201 is GDI data, the OS converts the GDI data to XPS data. Then, the OS transmits the converted XPS data to the general-purpose print software 202 as the intermediate data. Further, if data output from the drawing application 201 is XPS data, the OS transmits the XPS data to the general-purpose print software 202 as the intermediate data. Note that the intermediate data includes drawing data as information on characters, figures, and the like, which are to be formed on a printing medium, and the print setting information set by the user.

The general-purpose print software 202 converts the intermediate data to two data items which can be processed by the printing apparatus 102, i.e. generates two data items which can be processed by the printing apparatus 102 based on the intermediate data. As the first data, transmission image data for execution of FAX transmission (hereinafter referred to as the FAX data) is generated (first data generation step). As the second data, print image data for execution of printing (hereinafter referred to as the print data) is generated (second data generation step). Then, these two data items are transmitted to the printing apparatus 102. Here, the FAX data in the present embodiment is data to be transmitted from the printing apparatus 102 to one or more FAX transmission destinations (destinations), which are set by the IPP protocol. On the other hand, the print data in the present embodiment is page description language (PDL) data conforming to the IPP. The PDL data is, for example, data of the portable document format (PDF) or of the PWG-Raster format. Note that the print data includes drawing data as information on e.g. characters, figures, and the like, which are to be formed on a print sheet (printing medium), and print setting attribute information designating print settings, which is generated based on the print setting information set by the user. The print setting attribute information includes attribute information indicating functions which can be designated in the printing apparatus 102, i.e. the capabilities of the printing apparatus 102, and settings associated with the attribute information.

The printing apparatus 102 transmits the FAX data transmitted from the general-purpose print software 202 to a predetermined transmission destination by FAX. Further, the printing apparatus 102 performs printing on a print sheet based on the print data transmitted from the general-purpose print software 202. In doing this, the printing apparatus 102 can form an image on the print sheet based on the drawing data included in the print data, by performing operations according to the print setting attribute information included in the print data. Note that the print setting attribute information includes the attribute information for designating a print quality setting, such as image quality priority or speed priority, single-side printing or double-sided printing, and so forth, and settings of the attribute information. For example, in a case where attribute information designating double-sided printing is included in the print setting attribute information, the printing apparatus 102 can execute double-sided printing.

Referring to FIG. 2B, the configuration in the case where the extension application 204 is associated with the general-purpose print software 202 and the printing apparatus 102 will be described. As shown in FIG. 2B, differently from FIG. 2A, the extension application 204 is additionally provided. That is, the host computer 101 includes the drawing application 201, the general-purpose print software 202, and the print function information 203, and further has the extension application 204. The extension application 204 is software for extending the functions of the general-purpose print software 202. Note that the extension application 204 is software not included (packaged) in the OS in advance. Therefore, the extension application 204 is downloaded from a server (not shown) via the Internet and installed into the host computer 101 according to a user’s operation of the host computer 101. Alternatively, when the printing apparatus 102 is connected to the host computer 101, the extension application 204 can be automatically installed into the host computer 101 according to this connection. Specifically, in a case where the printing apparatus 102 is connected to the host computer 101, the OS acquires device identification information from the printing apparatus 102. The OS can download the extension application 204 associated with this device identification information from the server via the Internet and install the downloaded extension application 204. As a result, in the host computer 101, the general-purpose print software 202 and the extension application 204 are held as control programs different from each other. Note that the general-purpose print software 202 and the extension application 204 are sometimes updated and their versions are upgraded, respectively. The processing for updating the general-purpose print software 202 and the processing for updating the extension application 204 in this case are performed at the same timing or at different timings. Further, a trigger with which the general-purpose print software 202 is acquired by the host computer 101 and a trigger with which the extension application 204 is acquired by the host computer 101 can be the same trigger or different triggers. Further, in a case where the extension application 204 has been installed, the OS associates the extension application 204 with the general-purpose print software 202 and the printing apparatus 102.

As shown in FIG. 2B, the extension application 204 is capable of exchanging information with (transmitting and receiving information to and from) the general-purpose print software 202 and the printing apparatus 102. That is, the extension application 204 is associated with the general-purpose print software 202 and the printing apparatus 102. In the present embodiment, the extension application 204 includes a print setting screen-extending unit 205, a print function-extending unit 206, an intermediate data-editing unit 207, and a notification unit 209. Further, the extension application 204 includes shared information 208 which can be accessed from each of the print setting screen-extending unit 205, the print function-extending unit 206, the intermediate data-editing unit 207, and the notification unit 209. The shared information 208 is a file stored in the external storage device 114 or information stored in the RAM 113. The extension application 204 can write and read the shared information 208 by using an application program interface (API) provided by the OS.

Note that the extension application 204 can terminate the entire operation of the extension application 204 in accordance with termination of processing executed by each of the print setting screen-extending unit 205 to the notification unit 209. In this case, the OS starts the extension application 204 whenever a request for causing each unit to execute processing is received. Further, the OS terminates the entire operation of the extension application 204 in a case where processing executed e.g. by the print setting screen-extending unit 205 is terminated. Further, while the processing is being performed by each of the print setting screen-extending unit 205 to the notification unit 209, the extension application 204 can cancel this processing. In this case, a job being processed on a print queue is deleted by the OS. As described above, upon receipt of a FAX transmission request from a user, the drawing application 201 issues a FAX transmission instruction to the OS. Further, the drawing application 201 can display the print setting screen. In the configuration shown in FIG. 2B, the drawing application 201 can display the FAX transmission setting UI 211 provided by the print setting screen-extending unit 205 (the extension application 204). Further, the print setting screen-extending unit 205 can store detailed settings made by the user in the shared information 208.

The print setting screen-extending unit 205 displays, on the display section 119, a print setting UI (print setting screen) 210 for making print settings and the FAX transmission setting UI (FAX transmission setting screen) 211 for making FAX transmission settings. The intermediate data-editing unit 207 acquires intermediate data from the general-purpose print software 202. Then, the intermediate data-editing unit 207 converts the intermediate data to FAX data and print data and then transmits these data items to the printing apparatus 102. Further, the intermediate data-editing unit 207 acquires detailed setting information from the shared information 208 and adds the detailed settings to the FAX data and the print data. The printing apparatus 102 performs FAX transmission to a predetermined transmission destination based on the FAX data received from the intermediate data-editing unit 207. Further, the printing apparatus 102 performs printing on a sheet surface based on the print data received from the intermediate data-editing unit 207. Note that the extension application 204 can be configured to acquire FAX data and print data, generated by the general-purpose print software 202, and add the detailed settings to these data items, respectively. Further, also in the case of the configuration shown in FIG. 2B, there is a case where the simultaneous FAX transmission-and-printing setting is not executed. In this case, the general-purpose print software 202 can transmit FAX data and print data to the printing apparatus 102 without using the extension application 204.

The print function-extending unit 206 can edit the print function information 203 (PDC) generated by the general-purpose print software 202 or the OS. This makes it possible to add a function provided by the extension application 204. Further, it is also possible to add a function which can be executed by the printing apparatus 102 but cannot be executed by the general-purpose print software 202 (such as a thickness adjustment function) and add an exclusive relationship between settings of the print function. The OS starts the print function-extending unit 206 when the extension application 204 is associated with the printing apparatus 102 and the general-purpose print software 202 for the first time. Further, the OS can start the print function-extending unit 206 at a timing other than this (e.g. at a timing when the OS is started). By starting the print function-extending unit 206 as described above, even in a case where a function related to printing is extended later, the print function-extending unit 206 can detect the extended function and add the detected function to the print function information 203. Examples of the case where the function related to printing is extended later include a case where an optional apparatus (such as a finisher) is added to the printing apparatus 102 afterwards.

The notification unit 209 can provide, when an error of the printing apparatus 102 occurs, a notification indicating this fact. For example, if a paper-out error has occurred in the printing apparatus 102, the general-purpose print software 202 detects occurrence of this error. The OS displays a message indicating occurrence of the paper-out error as a result of the detection performed by the general-purpose print software 202 on the display section 119 by using a notification function called a toast notification which is one of the functions of the OS. Note that when the user operates the toast notification, the notification unit 209 is called by the OS, and a user interface screen (UI screen) of the notification unit 209 is displayed. On the user interface screen, for example, a detailed message concerning the paper-out error, a paper filling method, and so forth can be displayed.

As described above, in the present embodiment, it can be said that the extension application 204 has the following four functions: The first function is the function of displaying a setting screen. This function is executed by the print setting screen-extending unit 205. The second function is the function of editing intermediate data, converting the intermediate data to FAX data and print data, and adding detailed settings to these data items, respectively. This function is executed by the intermediate data-editing unit 207. The third function is the function of extending a function which can be designated by using print data generation software. This function is executed by the print function-extending unit 206. The fourth function is the function of displaying a screen in response to occurrence of an error in the printing apparatus 102. This function is executed by the notification unit 209. Note that the configuration of the extension application 204 is not limited to the configuration having these four functions but preferably includes at least one function of them, and further, the extension application 204 can be configured to further have another function.

FIGS. 3A-A to 3A-C are diagrams each showing an example of a screen displayed on the display section 119 of the printing system 1000 in a case where the printing apparatus has the FAX transmission function. FIGS. 3A-A shows the FAX transmission setting UI 301 displayed by the general-purpose print software 202 on the display section 119 of the host computer 101. FIGS. 3A-B and FIGS. 3A-C each show the FAX transmission setting UI 211 displayed by the extension application 204 on the display section 119 (display control step). As shown in FIGS. 3A-A, the FAX transmission setting UI 301 includes setting items 302, the button 309, and a button 310. With the setting items 302, the user can set, for example, a sheet size, image quality, an orientation of a sheet, and further a FAX number of a FAX receiver, which set when a FAX is to be transmitted. When the button 309 is operated, the use can display the FAX transmission setting UI 211. When the button 310 is operated, the user can instruct FAX transmission.

As shown in FIGS. 3A-B and 3A-C, the FAX transmission setting UI 211 includes a tab 303, a tab 304 and a button 311. As shown in FIGS. 3A-B, the tab 303 includes setting items 305. With the setting items 305, the user can set, for example, a sheet size, image quality, a layout, and an orientation of a sheet, which are set when a FAX is to be transmitted. Further, with the setting items 305, the user can set a plurality of destinations (transmission destinations) and select whether to enable/disable (set on/off of) broadcast transmission for transmitting the same image data to the plurality of destinations by one transmission instruction. Further, with the setting items 305, the user can select presence/absence (on/off) of a cover sheet on which information on a sender (FAX transmission source) and so forth are described, and whether to enable/disable (set on/off of) error diffusion which is one of image processing operations for improving image quality. Further, with the setting items 305, the user can select whether to enable/disable (set on/off of) simultaneous transmission-printing (setting selection section) 308 as the simultaneous FAX transmission-and-printing setting. Thus, the FAX transmission setting UI 211 has a function of a setting reception screen which receives the simultaneous FAX transmission-and-printing setting. As shown in FIGS. 3A-C, the tab 304 includes a destination list (transmission destination selection section) 306 registered in the RAM 113 in advance. The user can select one or more destinations from a plurality of destinations included in the destination list 306. For example, by operating the button 310 on the FAX transmission setting UI 301 in a state in which at least two destinations are selected from the destination list 306 and the broadcast transmission in the tab 303 is enabled, broadcast transmission is performed.

As described above, the general-purpose print software 202 cannot execute the function of receiving the simultaneous FAX transmission-and-printing setting. So, the extension application 204 can extend the function not supported by the general-purpose print software 202 such that the simultaneous FAX transmission-and-printing setting can be executed. Similar to the simultaneous FAX transmission-and-printing setting, the general-purpose print software 202 also cannot receive selection of whether to enable/disable broadcast transmission, selection of presence/absence of a cover sheet, and display of the destination list. To cope with this, the extension application 204 can extend the function not supported by the general-purpose print software 202 such that these settings can be made.

FIGS. 3B-A and 3B-B are diagrams useful in explaining simultaneous FAX transmission-and-printing. FIGS. 3B-A is a diagram showing a case where FAX data is displayed as an image. This FAX data can be generated by the general-purpose print software 202 or the extension application 204 and is transmitted by the printing apparatus 102 by FAX. FIGS. 3B-B is a diagram showing a case where print data is printed. The print data can be generated by the general-purpose print software 202 or the extension application 204 and is printed by the printing apparatus 102 to form a printed matter 900. The printed matter 900 is used as a backup when the FAX data is transmitted by FAX. With this, the contents of the FAX data can be kept within reach. The printed matter 900 includes a data area 901. In the data area 901, for example, the destination information is described. Further, in a case where a plurality of destinations are selected from the destination list 306, the plurality of selected destinations are described in the data area 901. Note that the data area 901 can be omitted.

FIGS. 3C-A and 3C-B are diagrams each showing an example of a screen displayed on the display section 119 of the printing system 1000 in a case where the printing apparatus does not have the FAX transmission function. The print setting UI 210 shown in FIGS. 3C-A and 3C-B is displayed on the display section 119 by the print setting screen-extending unit 205. As shown in FIGS. 3C-A, on the print setting UI 210, the user can set, for example, a sheet size, a sheet type, the number of copies to be printed, an orientation of a sheet, and image quality of printing, which are to be set when printing is performed. Further, when the user operates a scroll bar 1101, whether to enable/disable printing based on the number of copies, a position to be stapled, presence/absence of punched holes, a printing mode, and so forth are displayed, and the user can set these items.

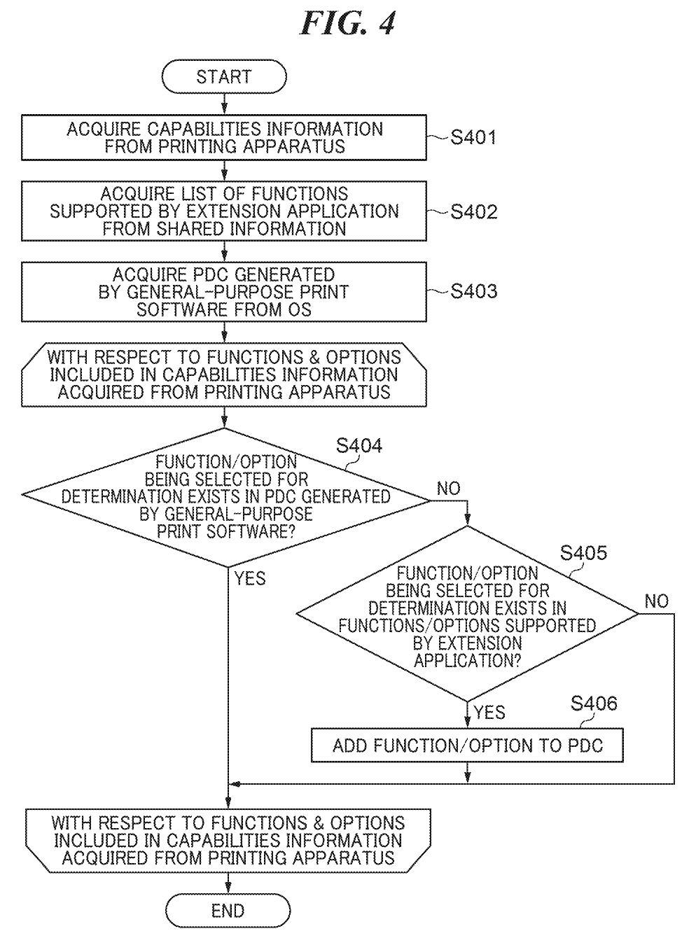

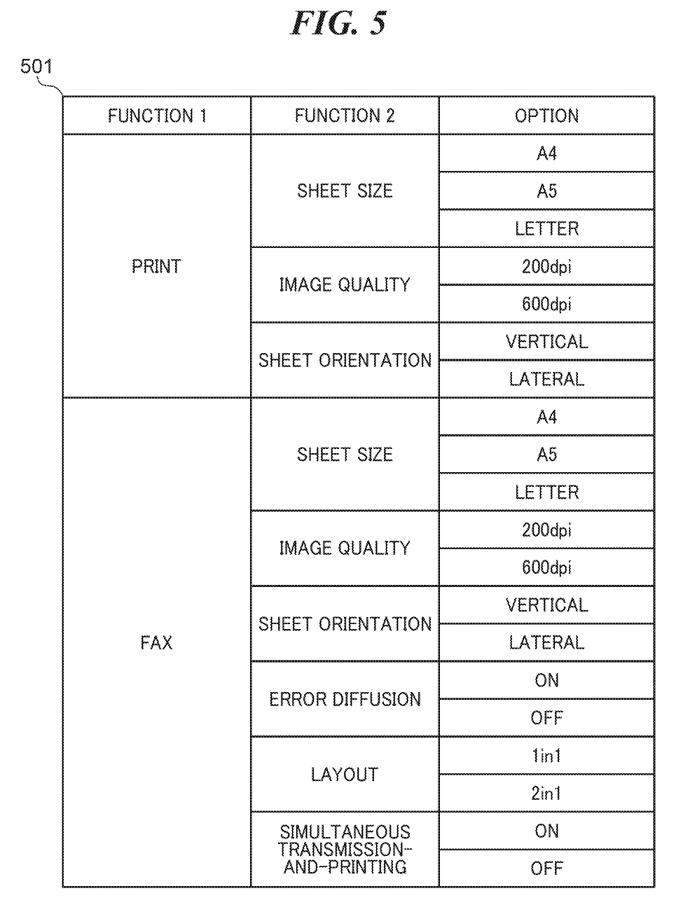

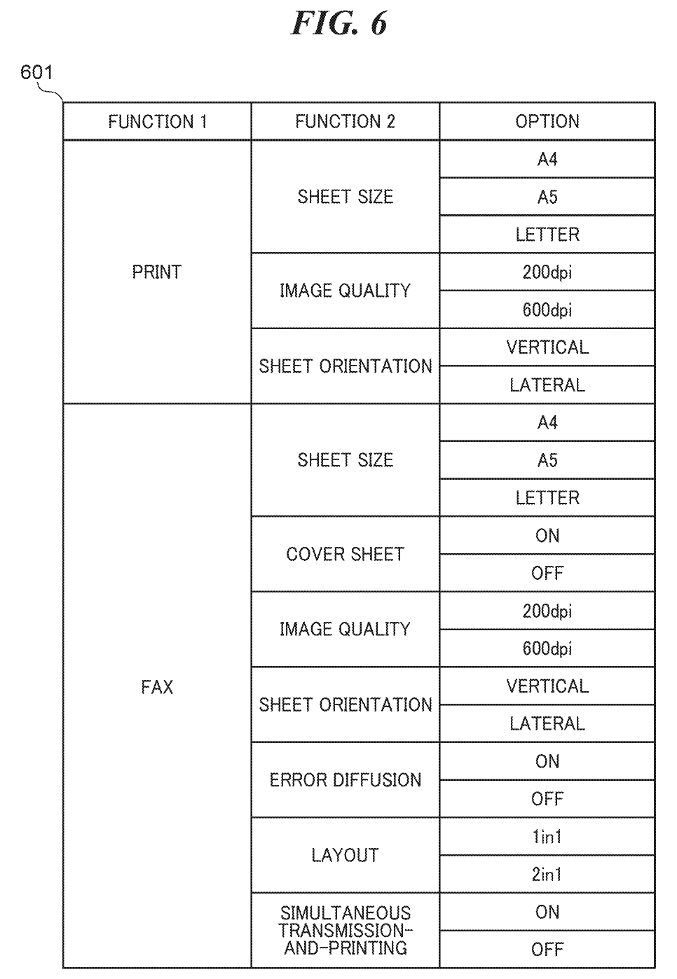

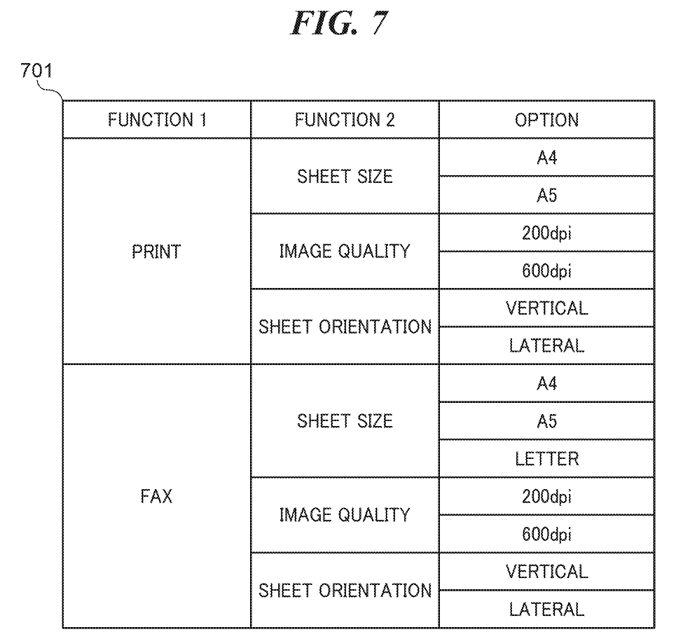

FIG. 4 is a flowchart of a process performed by the print function-extending unit 206, for editing the print function information. Note that a program of the process in FIG. 4 is executed by the print function-extending unit 206 under the control of the CPU 111. FIG. 5 is a diagram showing an example of a list of the capabilities information of the printing apparatus 102. FIG. 6 is a diagram showing an example of a list of the print functions supported by the extension application. FIG. 7 is a diagram showing an example of a list of the capabilities information of the general-purpose print software. Referring to FIG. 4, in a step S401, the print function-extending unit 206 acquires the capabilities information from the printing apparatus 102 before the above-described display control step (acquisition step). The capabilities information is information related to capabilities of the printing apparatus 102, for performing printing, and in the present embodiment, the capabilities information is information on settings included in a response acquired by issuing a “Get-Printer-Attributes” operation of the IPP to the printing apparatus 102. The settings are attribute information indicating the functions which can be designated in the printing apparatus 102 and settings related to this attribute information. A table 501 shown in FIG. 5 indicates a list of the capabilities information of the printing apparatus 102. The capabilities information includes capabilities information related to printing and capabilities information related to FAX transmission. For example, the capabilities information related to printing includes information related to sizes of sheets to be used for printing by the printing apparatus 102. The capabilities information related to FAX transmission includes, for example, information related to sizes of sheets and information related to the simultaneous FAX transmission-and-printing setting.

In a step S402, the print function-extending unit 206 acquires print functions supported by the extension application 204 from the shared information 208. In the shared information 208, a list of the print functions supported by the extension application 204 is stored. This list includes all print functions which can be processed by the extension application 204 and settings of these print functions. A table 601 shown in FIG. 6 includes, as the functions supported by the extension application, the capabilities information related to printing and the capabilities information related to FAX transmission. The capabilities information related to printing includes, for example, the information related to sizes of sheets to be used for printing by the printing apparatus 102. The capabilities information related to FAX transmission includes, for example, the information related to sizes of sheets, and further, the information related to the simultaneous FAX transmission-and-printing setting. Further, the functions supported by the extension application 204 are sometimes updated e.g. by the update of the extension application 204.

In a step S403, the print function-extending unit 206 acquires the print function information 203 generated by the general-purpose print software 202 from the OS. The print function information 203 is generated by the general-purpose print software 202 based on the capabilities information (see the table 501) acquired from the printing apparatus 102. The print function information 203 (PDC) generated by the general-purpose print software 202 includes only the functions supported by the general-purpose print software 202, out of the capabilities information acquired from the printing apparatus 102. For example, the table 601 shown in FIG. 6 includes “letter” as the sheet size, but in a table 701 shown in FIG. 7, the general-purpose print software 202 does not support the sheet size. Therefore, this sheet size is not included in the print function information 203. Further, the table 601 shown in FIG. 6 includes the information related to the simultaneous FAX transmission-and-printing setting, but in the table 701 shown in FIG. 7, the general-purpose print software 202 does not support the simultaneous FAX transmission-and-printing setting. Therefore, the simultaneous FAX transmission-and-printing setting is not included in the print function information 203. By adding a function and options to the print function information 203 by using the print function-extending unit 206, the extension application 204 can compensate for shortage of the functions of the general-purpose print software 202. Further, the print function-extending unit 206 is also capable of deleting an unnecessary function and options thereof from the print function information 203 generated by the general-purpose print software 202.

Steps S404, S405, and S406 are processing operations which are repeatedly executed on the list of the functions included in the capabilities information acquired from the printing apparatus 102 in the step S401. In the present embodiment, the steps S404, S405, and S406 are repeatedly executed on all of the 10 options included in the table 501.

In the step S404, the print function-extending unit 206 determines whether or not an option of a function, being currently selected for determination, exists in the print function information 203 generated by the general-purpose print software 202. If it is determined in the step S404 that the option of the function, being currently selected for determination, exists in the print function information 203, the present process is terminated provided that the option being selected for determination is the final item of the options of all the functions. Alternatively, if the option being selected for determination is not the final item of the options of all the functions, the next item of the options of the function or an option of the next function is selected, and the step S404 is executed again. On the other hand, if it is determined in the step S404 that the option of the function, being currently selected for determination, does not exist in the print function information 203, the process proceeds to the step S405. For example, in the present embodiment, the sheet size “A4” is included in the table 501, and the sheet size “A4” is also included in the table 701. In this case, it is determined in the step S404 that the option of the function, being currently selected for determination, exists in the print function information 203. On the other hand, “the simultaneous FAX transmission-and-printing setting” is included in the table 501 but “the simultaneous FAX transmission-and-printing setting” is not included in the table 701. In this case, it is determined in the step S404 that the option of the function, being currently selected for determination, does not exist in the print function information 203.

In the step S405, the print function-extending unit 206 determines whether or not the option of the function, being currently selected for determination, exists in the options of the functions supported by the extension application 204. If it is determined in the step S405 that the option of the function being currently selected for determination exists, the process proceeds to the step S406. On the other hand, if it is determined in the step S405 that the option of the function being currently selected for determination does not exist, similar to the case where the answer to the question of the step S404 is affirmative (YES), the present process is terminated provided that the option being selected for determination is the final item of the options of all the functions. Alternatively, if the option being selected for determination is not the final item of the options of all the functions, the next item of the options of the function or an option of the next function is selected, and the step S404 is executed again.For example, in the present embodiment, in a case where the function being currently selected for determination is related to “the simultaneous FAX transmission-and-printing setting”, “the simultaneous FAX transmission-and-printing setting” also exists in the table 601. Therefore, it is determined in the step S405 that the option of the function being currently selected for determination exists.

In the step S406, the print function-extending unit 206 adds the function and its option being currently selected for determination to the print function information 203. After execution of the step S406, similar to the case where the answer to the question of the step S404 is affirmative (YES), the present process is terminated provided that the option being selected for determination is the final item of the options of all the functions. Alternatively, if the option being selected for determination is not the final item of the options of all the functions, the next item of the options of the function or an option of the next function is selected, and the step S404 is executed again.

As described above, the extension application 204 can add, to the print function information 203, a function (and its options) which are not supported by the general-purpose print software 202 but are supported by the printing apparatus 102, and at the same time can be supported by the extension application 204. Then, the capabilities information (PC) is generated based on the print function information 203 edited by this addition processing. Further, by generating a display screen based on the resulting capabilities information, the print setting screen-extending unit 205 can extend the function not supported by the general-purpose print software 202 and display the FAX transmission setting UI 211 (see FIGS. 3A-B and 3A-C).

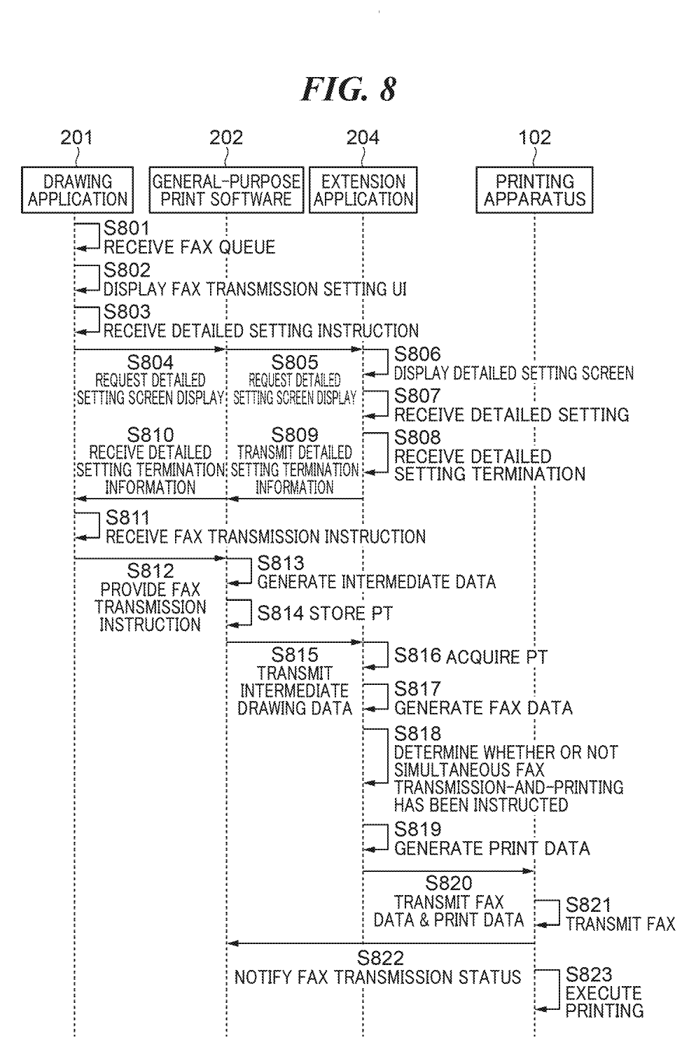

FIG. 8 is a sequence diagram showing a process executed between the drawing application 201, the general-purpose print software 202, the extension application 204, and the printing apparatus 102, after the drawing application 201 receives the FAX settings. Processing operations by the drawing application 201, the general-purpose print software 202, and the extension application 204 are executed by the CPU 111 of the host computer 101. A program of the process is stored in the external storage device 114. The CPU 111 loads the program of this process from the external storage device 114 into the RAM 113 and executes the loaded program. Further, processing operations performed by the printing apparatus 102 are executed by the CPU (not shown) of the printing apparatus 102. Further, the software configuration of the printing system 1000 is the software configuration shown in FIG. 2B.

Referring to FIG. 8, in a step S801, the drawing application 201 receives the FAX transmission (FAX queue) setting provided by the user. The user can instruct the FAX transmission setting to the drawing application 201 by operating e.g. the pointing device 117 or the keyboard 118.

In a step S802, the drawing application 201 displays the FAX transmission setting UI 301 shown in FIGS. 3A-A on the display section 119.

In a step S803, the drawing application 201 receives a detailed setting instruction provided by the user. The user can instruct display of the detailed setting screen by operating e.g. the pointing device 117 or the keyboard 118 to select the button 309 on the FAX transmission setting UI 301.

In a step S804, the drawing application 201 requests the general-purpose print software 202 to display the detailed setting screen.

In a step S805, the general-purpose print software 202 requests the extension application 204 to display the detailed setting screen.

In a step S806, the print setting screen-extending unit 205 of the extension application 204 displays the FAX transmission setting UI 211 (detailed setting screen) shown in FIGS. 3A-B in response to the request received in the step S805. As described hereinabove, the simultaneous FAX transmission-and-printing setting is added to the print function information 203 (PDC) by the print function-extending unit 206. The print setting screen-extending unit 205 can display the FAX transmission setting UI 211 by referring to the capabilities information (PC) generated based on the print function information 203 to which the simultaneous FAX transmission-and-printing setting has been added.

In a step S807, the print setting screen-extending unit 205 receives detailed settings input by the user on the FAX transmission setting UI 211. On the FAX transmission setting UI 211, it is assumed, by way of example, that the sheet size of “A4”, the image quality of “normal”, the layout of “1in1”, the broadcast transmission of “on”, the sheet orientation of “vertical”, the cover sheet setting of “on”, the error diffusion of “on”, the simultaneous transmission-printing 308 of “on” are selected.

In a step S808, the print setting screen-extending unit 205 receives an operation of pressing the button 311 in the setting state in the step S807. With this, the detailed setting is terminated. Note that the user can instruct termination of the detailed setting operation by selecting the button 311 through operating e.g. the pointing device 117 or the keyboard 118.

In a step S809, the extension application 204 transmits detailed setting termination information that the detailed setting operation in the step S808 has been terminated, to the general-purpose print software 202.

In a step S810, the general-purpose print software 202 receives the detailed setting termination information sent from the extension application 204 in the step S809. Then, the general-purpose print software 202 transmits this detailed setting termination information to the drawing application 201.

In a step S811, the drawing application 201 receives a FAX transmission instruction provided by the user. The user can instruct FAX transmission by operating e.g. the pointing device 117 or the keyboard 118 to select the button 310 on the FAX transmission setting UI 301.

In a step S812, the drawing application 201 provides the FAX transmission instruction received in the step S811 to the general-purpose print software 202.

In a step S813, the general-purpose print software 202 generates intermediate data based on the FAX transmission instruction received in the step S812 by using a module of the OS.

In a step S814, the general-purpose print software 202 stores the print setting information (PT) based on the FAX transmission instruction received in the step S812 in the shared information 208.

In a step S815, the general-purpose print software 202 transmits drawing data (image data) out of the intermediate data generated in the step S813 to the extension application 204.

In a step S816, the intermediate data-editing unit 207 of the extension application 204 acquires the print setting information stored in the step S814 from the shared information 208. Further, the intermediate data-editing unit 207 also acquires the drawing data transmitted in the step S815.

In a step S817, the intermediate data-editing unit 207 of the extension application 204 generates FAX data using the drawing data and the print setting information, acquired in the step S816 (first data generation step).

In a step S818, the print setting screen-extending unit 205 of the extension application 204 determines whether or not the simultaneous transmission-and-printing 308 of “on” has been selected on the FAX transmission setting UI 211, i.e. whether or not the simultaneous FAX transmission-and-printing setting has been made. If it is determined in the step S818 that the simultaneous transmission-and-printing 308 of “on” has been selected, the process proceeds to a step S819. On the other hand, if it is determined in the step S818 that the simultaneous transmission-and-printing 308 of “on” has not been selected, i.e. “off” has been selected, the process proceeds to a step S820.

In the step S819, the intermediate data-editing unit 207 of the extension application 204 generates print data using the drawing data and the print setting information, acquired in the step S816 (second data generation step).

In the step S820, the intermediate data-editing unit 207 of the extension application 204 transmits the FAX data generated in the step S817 and the print data generated in the step S819 to the printing apparatus 102. With this transmission of the data used for the simultaneous FAX transmission-and-printing, it is possible to instruct the printing apparatus 102 to execute the simultaneous FAX transmission-and-printing (instruction step). Note that in the step S820, the extension application 204 can store these data items as a log.

In a step S821, the printing apparatus 102 receives the FAX data and the print data, transmitted in the step S820. Then, the printing apparatus 102 transmits this FAX data to a destination selected from the destination list 306 by FAX.

In a step S822, the printing apparatus 102 notifies a FAX transmission status indicating whether or not the FAX transmission processing in the step S821 has been successfully performed to the general-purpose print software 202.

In a step S823, the printing apparatus 102 prints the print data received in the step S821. Note that the step S823 can be executed before the steps S821 and S822.

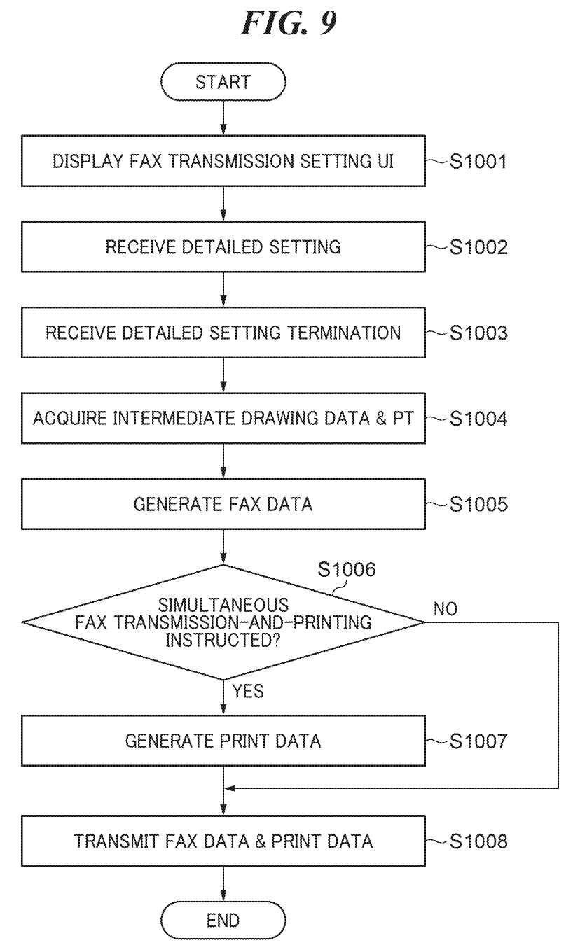

FIG. 9 is a flowchart of a process performed by the extension application. Note that a program of the process in FIG. 9 is executed by the print function-extending unit 206 under the control of the CPU 111. As shown in FIG. 9, in a step S1001, the extension application 204 displays the FAX transmission setting UI 211 shown in FIGS. 3A-B (see the step S806) in response to the request received from the general-purpose print software 202 (see the step S805).

In a step S1002, the extension application 204 receives the detailed settings input on the FAX transmission setting UI 211 (see the step S807).

In a step S1003, the extension application 204 receives termination of the detailed setting on the FAX transmission setting UI 211 (see the step S808).

In a step S1004, the extension application 204 acquires the drawing data (intermediate drawing data) and the print setting information (see the step S816).

In a step S1005, the extension application 204 generates the FAX data using the drawing data and the print setting information, acquired in the step S816 (see the step S817).

In a step S1006, the extension application 204 determines whether or not the simultaneous transmission-and-printing 308 of “on” has been selected on the FAX transmission setting UI 211 (see the step S818). If it is determined in the step S1006 that the simultaneous transmission-and-printing 308 of “on” has been selected, the process proceeds to a step S1007. On the other hand, if it is determined that the simultaneous transmission-and-printing 308 of “off” has been selected, the process proceeds to a step S1008.

In the step S1007, the extension application 204 generates the print data using the drawing data and the print setting information, acquired in the step S816 (see the step S820).

In the step S1008, the extension application 204 transmits the FAX data generated in the step S1005 and the print data generated in the step S1007 to the printing apparatus 102 (see the step S820). Note that, when the step S1008 is executed after execution of the step S1006 without via the step S1007, the extension application 204 transmits only the FAX data generated in the step S1005 to the printing apparatus 102.

As described above, even in a case where the general-purpose print software 202 does not support the simultaneous FAX transmission-and-printing setting, the extension application 204 can display the FAX transmission setting UI 211 which enables the simultaneous FAX transmission-and-printing setting. This makes it possible to cause the printing apparatus 102 to simultaneously execute FAX transmission and printing of image data. That is, in the printing system 1000, it is possible to set image data generated in the host computer 101 to a common execution target of the FAX function and the print function executed by the printing apparatus 102, by an operation on the FAX transmission setting UI 211. Then, with an operation on the FAX transmission setting UI 301, it is possible to instruct the printing apparatus 102 to execute the FAX function and the print function. Further, although the extension application 204 generates the print data from the intermediate data generated by the general-purpose print software 202 in the present embodiment, this is not limitative, but, for example, the extension application 204 itself can generate the intermediate data. Further, although the extension application 204 generates the FAX data, this is not limitative, but, for example, the general-purpose print software 202 can generate FAX data.

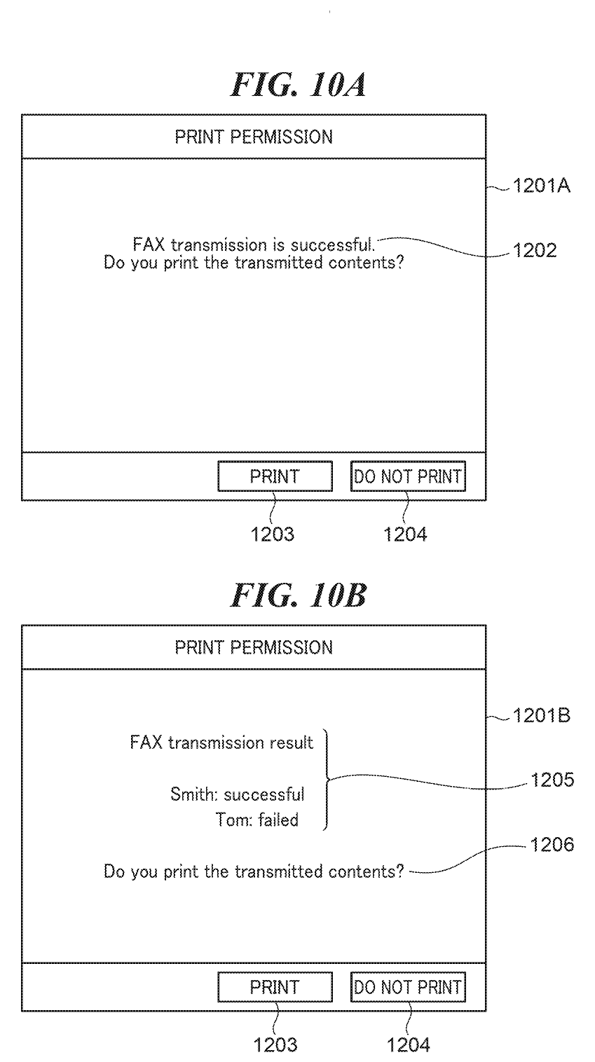

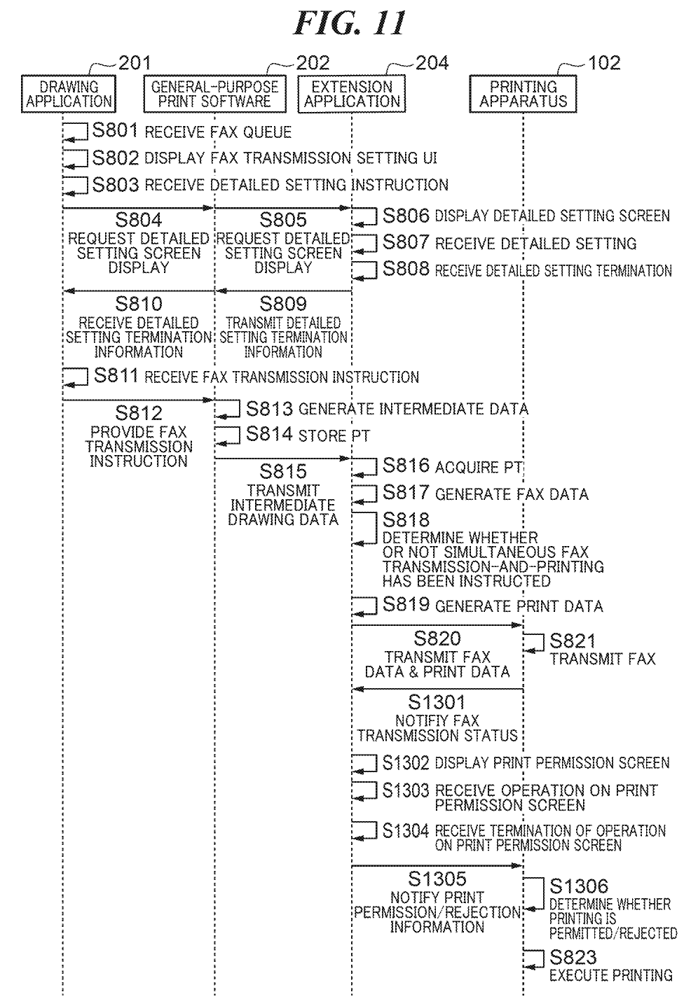

A second embodiment will be described below with reference to FIGS. 10A to 11, but the description will be given mainly of different points from the above-described embodiment, and description of the same points is omitted. In the first embodiment, the printing apparatus 102 can execute printing of print data regardless of whether or not FAX transmission is successful. On the other hand, it is desired to print the print data only in a case where FAX transmission is successful. In the present embodiment, a description will be given of this.

FIG. 10A is a diagram showing an example of a screen displayed on the display section 119 of the printing system 1000 according to the second embodiment. A print permission screen 1201A shown in FIG. 10A is displayed on the display section 119 by the extension application 204. The print permission screen 1201A includes a message 1202, a button 1203, and a button 1204. The message 1202 is a message notifying that transmission of FAX data by the printing apparatus 102 has been successful or has failed according to the FAX transmission status (see the step S822). Further, the message 1202 also includes a message for prompting the user to determine whether or not to print the print data (contents of FAX transmission). By operating the button 1203, printing of print data in the printing apparatus 102 is permitted. On the other hand, by operating the button 1204, printing of print data in the printing apparatus 102 is rejected. In the present embodiment, in a case where transmission of FAX data is successful, the user can instruct the printing apparatus 102 to execute printing of the print data on the print permission screen 1201A. Note that in a case where FAX transmission has failed, as the message 1202, for example, there can be displayed “FAX transmission has failed. Do you print the contents to be transmitted?”.

FIG. 10B is a diagram showing a variation of the screen displayed on the display section 119 of the printing system 1000 according to the second embodiment. A print permission screen 1201B shown in FIG. 10B includes a message 1205, a message 1206, the button 1203, and the button 1204. The message 1205 is a result of success/failure in each FAX transmission in a case where a FAX has been transmitted to a plurality of destinations. In the illustrated example in FIG. 10B, in a case where a FAX has been transmitted to Smith and Tom, FAX transmission to Smith has been successful, but FAX transmission to Tom has failed, by way of example. The message 1206 is a message for prompting the user to determine whether or not to print the print data. Thus, also in a case where the success and failure in FAX transmission are mixed, the user can select permission/non-permission of printing of print data.

FIG. 11 is a sequence diagram showing a process executed between the drawing application 201, the general-purpose print software 202, the extension application 204, and the printing apparatus 102, after the drawing application 201 receives FAX settings. Different from the sequence diagram shown in FIG. 8, in the sequence diagram shown in FIG. 11, steps S1301 to S1306 are added in place of the step S822. As shown in FIG. 11, in the step S1301, the printing apparatus 102 notifies the FAX transmission status indicating success/failure in the FAX transmission processing in the step S821 to the extension application 204.

In the step S1302, the print setting screen-extending unit 205 of the extension application 204 displays the print permission screen 1201A (See FIG. 10A) on the display section 119.

In the step S1303, the print setting screen-extending unit 205 receives an operation of the button 1203 or the button 1204 on the print permission screen 1201A.

In the step S1304, the print setting screen-extending unit 205 receives termination of the operation on the print permission screen 1201A based on reception of the operation in the step S1303.

In the step S1305, the print setting screen-extending unit 205 transmits print permission information based on the operation of the button 1203 or print rejection information based on the operation of the button 1204, which is performed on the print permission screen 1201A in the step S1303, to the printing apparatus 102.

In the step S1306, the printing apparatus 102 receives the information transmitted in the step S1305. Then, the printing apparatus 102 determines based on this information whether printing is permitted or rejected. If it is determined that printing is permitted, the process proceeds to the step S823. On the other hand, if it is determined that printing is rejected, the process is terminated.

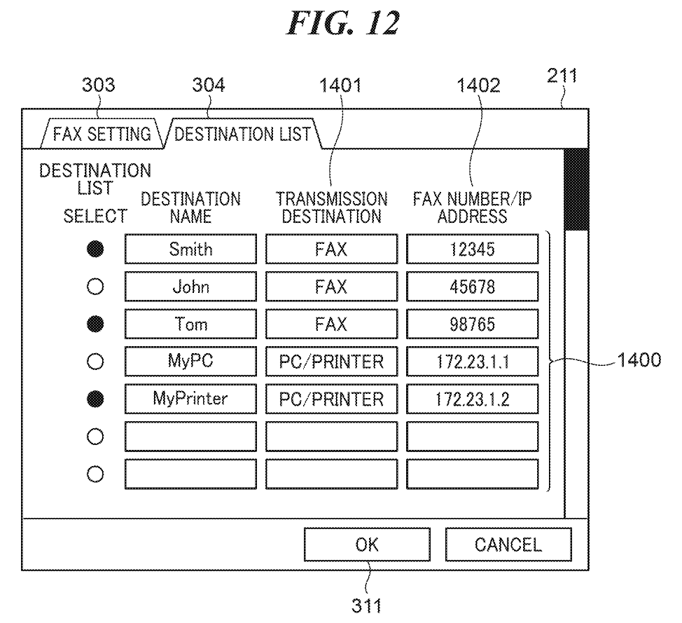

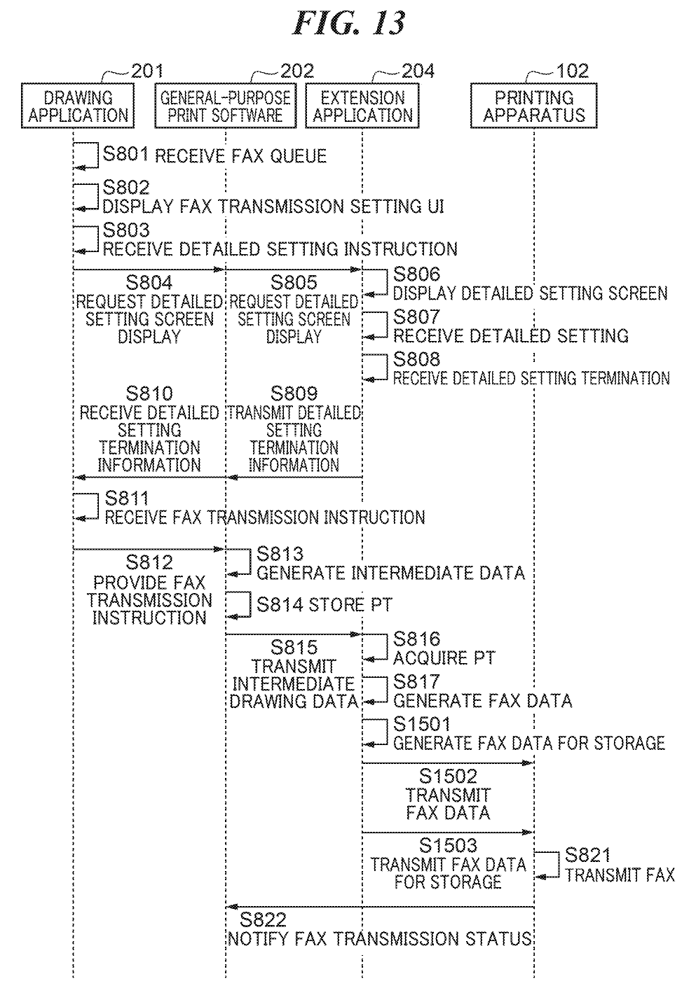

A third embodiment will be described below with reference to FIGS. 12 and 13, but the description will be given mainly of different points from the above-described embodiments, and description of the same points is omitted.

FIG. 12 is a diagram showing an example of a screen displayed on the display section 119 of the printing system 1000 in a case where the printing apparatus according to the third embodiment has the FAX transmission function. As shown in FIG. 12, the tab 304 includes a destination list 1400 registered in the RAM 113 in advance. The destination list 1400 includes transmission destination settings 1401 and transmission destination addresses 1402. In the transmission destination settings 1401, in a case where FAX transmission is to be performed, “FAX” registered in advance is set, and in a case where a storage destination where FAX data is stored is to be designated, “PC/printer” registered in advance is set. In the transmission destination address 1402, in a case where “FAX” is selected in the transmission destination settings 1401, a FAX number registered in advance is set, and in a case where “PC/printer” is selected in the transmission destination settings 1401, for example, an IP address registered in advance is set. With this destination list 1400, it is possible to store FAX data in a predetermined storage section (PC or printer) according to a simultaneous FAX transmission-and-printing instruction (storage step). This makes it possible to store the FAX data for a long period of time.

FIG. 13 is a sequence diagram showing a process executed between the drawing application 201, the general-purpose print software 202, the extension application 204, and the printing apparatus 102, after the drawing application 201 receives FAX settings. Different from the sequence diagram shown in FIG. 8, in the sequence diagram shown in FIG. 13, steps S1501 to S1503 are added in place of the steps S818 to S820. Further, the step S823 is deleted. Note that here, although the printing apparatus 102 is used as the storage destination of the FAX data, this is not limitative, but, for example, the FAX data can be stored in the external storage device 114 of the host computer 101.

As shown in FIG. 13, in the step S1501, the intermediate data-editing unit 207 of the extension application 204 generates FAX data for storage by using the drawing data and the print setting information, which are acquired in the step S816. The FAX data for storage can be the same data as the FAX data generated in the step S817 but is not limited to this. For example, the FAX data for storage can be data obtained by compressing the drawing data in the Joint Photographic Experts Group (JPEG) format.

In the step S1502, the intermediate data-editing unit 207 transmits the FAX data generated in the step S817 to the printing apparatus 102.

In the step S1503, the intermediate data-editing unit 207 transmits the FAX data for storage generated in the step S1501 to the printing apparatus 102 as the storage destination of the FAX data. With this, the FAX data for storage is stored in the printing apparatus 102.

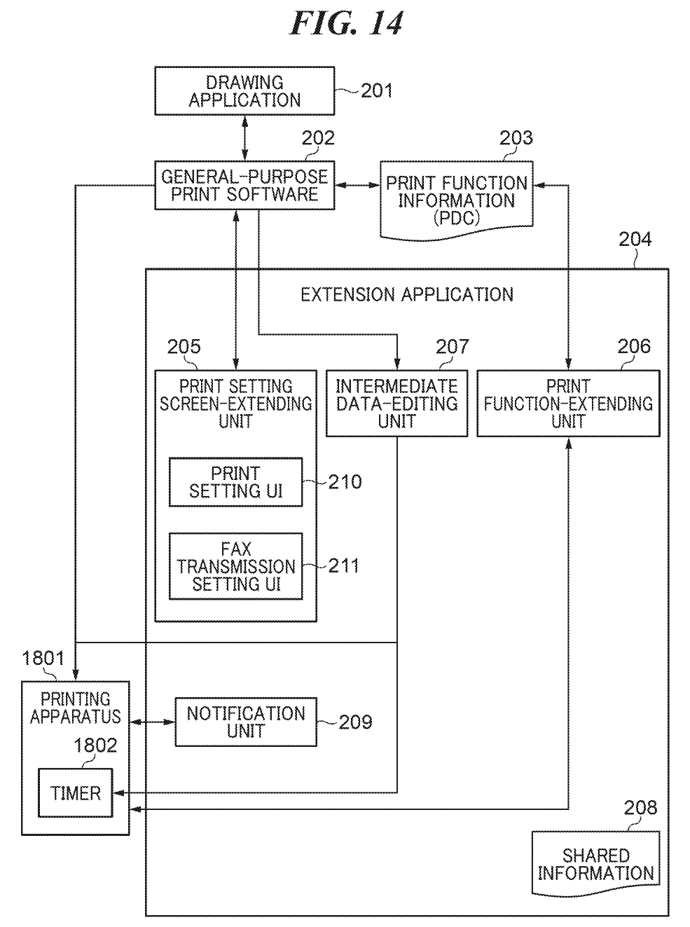

A fourth embodiment will be described below with reference to FIGS. 14 to 16, but the description will be given mainly of different points from the above-described embodiments, and description of the same points is omitted.

FIG. 14 is a block diagram showing a software configuration of the printing system according to the fourth embodiment. As shown in FIG. 14, a printing apparatus 1801 has a timer 1802. The timer 1802 can interpret a transmission time included in FAX data transmitted from the extension application 204. Further, the timer 1802 can cause FAX transmission to wait until the transmission time comes. Then, when the transmission time comes, the timer 1802 notifies execution of FAX transmission to the printing apparatus 1801.

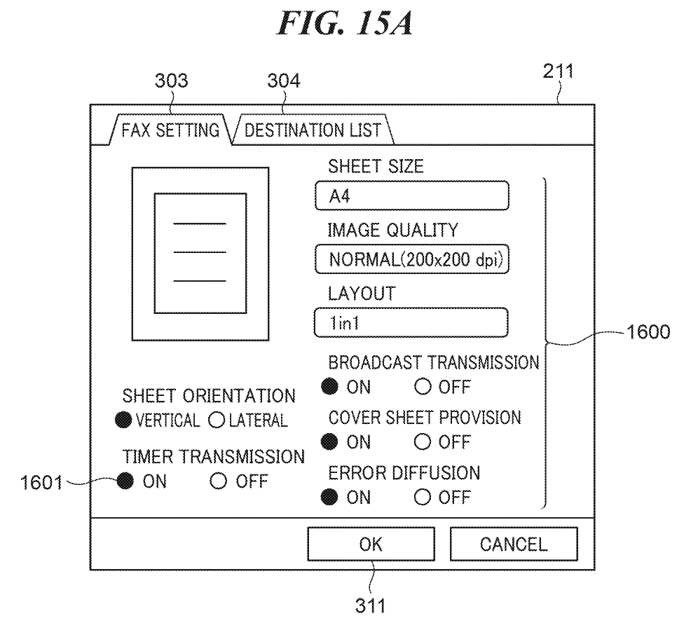

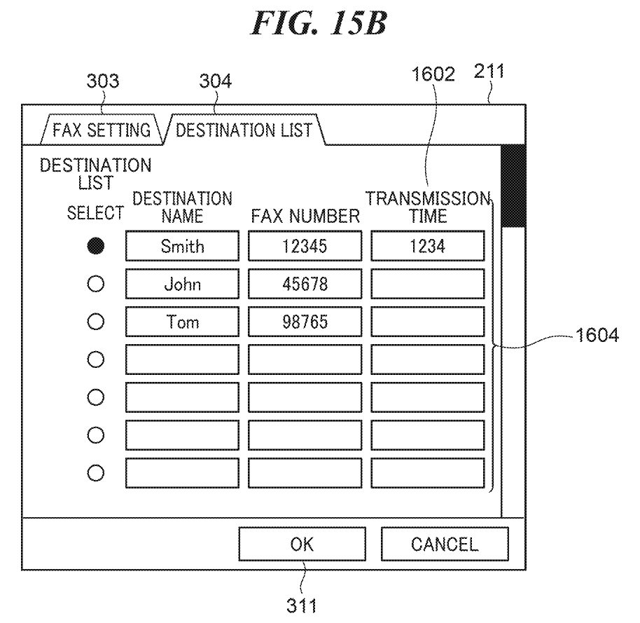

FIGS. 15A and 15B are diagrams each showing an example of a screen displayed on the display section 119 of the printing system 1000 in a case where the printing apparatus has the FAX transmission function. FIGS. 15A and 15B each show the FAX transmission setting UI 211 displayed by the extension application 204. As shown in FIG. 15A, the tab 303 on the FAX transmission setting UI 211 includes setting items 1600. With the setting items 1600, the user can select whether to enable/disable (set on/off of) the timer transmission function of the timer 1802 in a timer transmission 1601. As shown in FIG. 15B, the tab 304 includes a destination list 1604 registered in the RAM 113 in advance. The destination list 1604 includes a transmission time setting 1602 for setting a time to transmit a FAX from the printing apparatus 1801. In the transmission time setting 1602, for example, “1234” can be input. A numeral “12” of this “1234” expresses an “hour (24-hour notation)”, and a numeral “34” expresses a “minute”. Therefore, “1234” indicates that the timer transmission time is set such that a FAX is to be transmitted at “12:34”. Thus, in the present embodiment, it is possible to adjust the timing of instructing the printing apparatus 1801 to execute transmission of FAX data, which improves the convenience. Note that the number of digits of a numeral input to the transmission time setting 1602 is not limited to 4. Further, a value to be input to the transmission time setting 1602 is not limited to a numeral. Further, in a case where the transmission time setting 1602 is blank, timer transmission is not performed, but real-time FAX transmission is performed. Further, in a case where the FAX transmission time is set to a time before a time at which FAX transmission was actually executed, FAX transmission is executed, for example, at the set time on the next day.

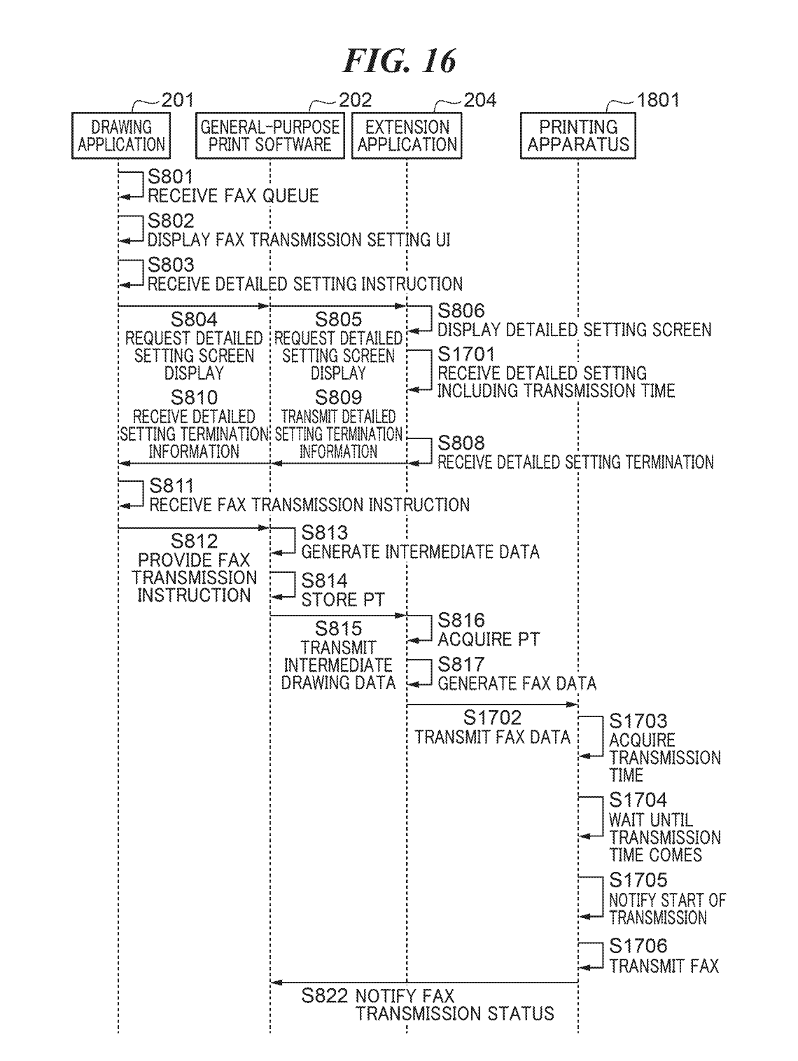

FIG. 16 is a sequence diagram showing a process executed between the drawing application 201, the general-purpose print software 202, the extension application 204, and the printing apparatus 1801, after the drawing application 201 receives FAX settings. Different from the sequence diagram shown in FIG. 8, in the sequence diagram shown in FIG. 16, a step S1701 is added in place of the step S807, and steps S1702 to S1706 are added in place of the steps S818 to S821. Further, the step S823 is deleted. As shown in FIG. 16, in the step S1701, the print setting screen-extending unit 205 of the extension application 204 receives detailed settings made by the user on the FAX transmission setting UI 211. It is assumed here, by way of example, that the sheet size of “A4”, the image quality of “normal”, the layout of “1in1”, the broadcast transmission of “on”, the sheet orientation of “vertical”, the cover sheet setting of “on”, the error diffusion of “on”, and timer transmission 1601 of “on” are selected, on the FAX transmission setting UI 211. Further, it is assumed that the destination name of “Smith”, the FAX number of “12345” and the transmission time of “12:34” are set.

In the step S1702, the intermediate data-editing unit 207 of the extension application 204 transmits the FAX data generated in the step S817 to the printing apparatus 1801.

In the step S1703, the timer 1802 of the printing apparatus 1801 acquires the FAX transmission time included in the FAX data transmitted in the step S1702.

In the step S1704, the timer 1802 waits without performing FAX transmission until the FAX transmission time acquired in the step S1703 comes.

In the step S1705, the timer 1802 notifies a CPU (not shown) of the printing apparatus 1801 that FAX transmission will be started when the FAX transmission time comes.

In the step S1706, the CPU of the printing apparatus 1801 transmits the FAX data to the destination name of “Smith” by FAX.

As described above, in the present embodiment, it is possible to transmit FAX data to a predetermined transmission destination at a desired timing. With this, it is possible to reduce a risk that confidential information or the like included in the FAX data is left at the transmission destination.

According to the present disclosure, it is possible to instruct the image processing apparatus to execute the FAX function and the print function by setting image data as a common execution target of these functions of the image processing apparatus,.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-230192, filed December 26, 2024, which is hereby incorporated by reference herein in its entirety.

What is claimed is:

1. A non-transitory computer-readable storage medium storing an application program causing a computer to execute a method, the method comprising:
supporting a standard driver provided from a provider of an operating system; and
displaying a setting reception screen which receives a setting for executing both of processing for transmitting image data and processing for performing printing based on the image data.

2. The non-transitory computer-readable storage medium according to claim 1, wherein the method further comprises:
acquiring, from an image processing apparatus, capabilities information related to capabilities of the image processing apparatus before displaying the setting reception screen, and
determining whether or not information which enables execution of both of the processing operations is included in the acquired capabilities information.

3. The storage medium according to claim 2, wherein in a case where it is determined that the information which enables execution of both of the processing operations is included, display of the setting reception screen is executed, and in a case where it is determined that the information which enables execution of both of the processing operations is not included, display of the setting reception screen is not executed.

4. The storage medium according to claim 2, wherein the method further comprises instructing the image processing apparatus to execute both of the processing operations based on the setting received on the setting reception screen.

5. The storage medium according to claim 4, wherein the method further comprises generating transmission image data for execution of transmission of the image data, and generating printing image data for execution of the printing, between the displaying of the setting reception screen and the instructing of execution of both of the processing operations,.

6. The storage medium according to claim 5, wherein the transmission image data and the printing image data are transmitted according to an instruction for executing both of the processing operations.

7. The storage medium according to claim 4, wherein in a case where execution of transmission of the image data is instructed to the image processing apparatus, and execution of transmission of the image data is successful, execution of the printing can be instructed to the image processing apparatus.

8. The storage medium according to claim 4, wherein the method further comprises storing the image data in a predetermined storage section according an instruction for executing both of the processing operations.

9. The storage medium according to claim 4, wherein a timing of instructing the image processing apparatus to execute transmission of the image data can be adjusted.

10. The storage medium according to claim 1, wherein the setting reception screen includes a setting selection section for selecting whether to enable or disable the setting.

11. The storage medium according to claim 1, wherein the setting reception screen includes a transmission destination selection section for selecting a transmission destination to be set when transmission of the image data is executed.

12. The storage medium according to claim 11, wherein the transmission destination selection section includes a plurality of the transmission destinations, and at least two transmission destinations can be selected from the plurality of the transmission destinations.

13. The storage medium according to claim 1, wherein the function of receiving the setting is a function which cannot be executed by the standard driver.

14. A control method comprising:
supporting a standard driver provided from a provider of an operating system by executing an application program; and
displaying, by executing the application program, a setting reception screen which receives a setting for executing both of processing for transmitting image data and processing for performing printing based on the image data.

15. An information processing apparatus comprising,
supporting means for supporting a standard driver provided from a provider of an operating system by executing an application program, and
displaying means for displaying, by executing the application program, a setting reception screen which receives a setting for executing both of processing for transmitting image data and processing for performing printing based on the image data.
